(19) United States
(12) Patent Application Publication
(10) Pub. No.: US 2026/0087568 A1
(43) Pub. Date: Mar. 26, 2026

(54) SYSTEMS AND METHODS FOR MATCHING A FOOD SURPLUS TO A USER

(71) Applicants: Joseph BAIO, Orland Park, IL (US); Peter BAIO, Orland Park, IL (US); Helena KLOOSTER, Orland Park, IL (US); Jacob KLOOSTER, Orland Park, IL (US)

(72) Inventors: Joseph BAIO, Orland Park, IL (US); Peter BAIO, Orland Park, IL (US); Helena KLOOSTER, Orland Park, IL (US); Jacob KLOOSTER, Orland Park, IL (US)

(21) Appl. No.: 18/893,252

(22) Filed: Sep. 23, 2024

(51) Int. Cl. G06Q 50/12; G06Q 30/0601

(52) U.S. Cl. CPC G06Q 50/12; G06Q 30/0611

(57) ABSTRACT

A method of matching vendors supplying food products with users. The method includes storing information associated with vendors in a first database and storing user profiles in a second database. The method includes receiving an availability offer based on input from one of the vendors and comparing information associated with the availability offer to data from the second database associated with the users to identify a matching user. The method includes electronically transmitting an offer notification and an acceptance prompt to a first device of the matching user. The method includes waiting a predetermined time period for a feedback signal from the first device indicating acceptance of the offer notification. If the feedback signal is not received within the predetermined time period, an offer cancellation notice is electronically transmitted to the first device, and the offer notification is electronically submitted to a second device of a second matching user.

### TECHNICAL FIELD

The present disclosure relates to efficiently managing a surplus of goods and, more specifically, to systems and methods for matching a food surplus to a user based on global positioning system data, information, and/or preferences associated with the user.

### BACKGROUND

The world produces enough food to feed all of its billions of people. Still, hunger and famine are serious issues affecting millions of people who do not have enough food to cat or the means to access available food supplies. In fact, one in five children does not have enough food to cat. What more, these numbers are constantly increasing.

Conversely, more than one-third of all food produced in the world is wasted. Not only is food waste a social problem, but it also leads to environmental problems such as excess landfill and undesirable release of greenhouse gases. It can also be costly to dispose of food waste.

It would be desirable to match people in need with restaurants, grocery stores, and the like that have excess food to simultaneously assist in minimizing hunger and food waste.

### SUMMARY

According to some implementations of the present disclosure, a method of matching vendors supplying food products with users that seek food products is disclosed. The method includes storing information associated with a plurality of vendors in a first database. The method further includes storing user profiles associated with a plurality of users in a second database. The method further includes receiving an availability offer based on input from one of the plurality of vendors. The method further includes comparing information associated with the availability offer to data associated with the plurality of users to identify at least one matching user from the plurality of users whose data aligns with the availability offer. The data includes information stored in the second database. The method further includes electronically transmitting an offer notification and an acceptance prompt to a first device of the at least one matching user. The offer notification includes information associated with the availability offer. The method further includes waiting a predetermined time period for a feedback signal from the first device indicating acceptance of the offer notification. If the feedback signal is not received within the predetermined time period, an offer cancellation notice is electronically transmitted to the first device, and the offer notification is electronically submitted to a second device of a second at least one matching user.

According to some implementations of the present disclosure, a system for matching vendors supplying food products with users that seek food products is disclosed. The system is configured to store information associated with a plurality of vendors in a first database. The system is further configured to store user profiles associated with a plurality of users in a second database. The system is further configured to receive an availability offer based on input from one of the plurality of vendors. The system is further configured to compare information associated with the availability offer to data associated with the plurality of users to identify at least one matching user from the plurality of users whose data aligns with the availability offer. The data includes information stored in the second database. The system is further configured to electronically transmit an offer notification and an acceptance prompt to a first device of the at least one matching user. The offer notification includes information associated with the availability offer. The system is further configured to wait a predetermined time period for a feedback signal from the first device indicating acceptance of the offer notification. If the feedback signal is not received within the predetermined time period, the system is further configured to electronically transmit an offer cancellation notice to the first device and electronically submitting the offer notification to a second device of a second at least one matching user.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 is a functional block diagram of a computer system according to an aspect of the present disclosure.

FIG. 2 is a flowchart of a computer-implemented method or algorithm of matching vendors supplying food products with users that seek food products according to aspects of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

While this disclosure is susceptible of embodiment in many different forms, there is shown in the drawings and will herein be described in detail example implementations of the inventions and concepts herein with the understanding that the present disclosure is to be considered as an exemplification of the principles of the inventions and concepts and is not intended to limit the broad aspect of the disclosed implementations to the examples illustrated. For purposes of the present detailed description, the singular includes the plural and vice versa (unless specifically disclaimed), the words “and” and “or” shall be both conjunctive and disjunctive, the word “all” means “any and all,” the word “any” means “any and all,” and the word “including” means “including without limitation.”

A (software) module can refer to computer-readable object code that executes a software sub-routine or program, which corresponds to instructions executed by any microprocessor or microprocessing device to perform described functions, acts, or steps. Any of the methods or algorithms or functions described herein can include non-transitory machine or computer-readable instructions for execution by: (a) an electronic processor, (b) an electronic controller, and/or (c) any other suitable electronic processing device. Any algorithm, software module, software component, software program, routine, sub-routine, or software application, or method disclosed herein can be embodied as a computer program product having one or more non-transitory tangible medium or media, such as, for example, a flash memory, a CD-ROM, a floppy disk, a hard drive, a digital versatile disk (DVD), or other electronic memory devices, but persons of ordinary skill in the art will readily appreciate that the entire algorithm and/or parts thereof could alternatively be executed by a device other than an electronic controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.).

Hunger and lack of food remain critical issues in today's society, especially with constantly increasing food prices. Many people and families lack economic resources to purchase enough food, resulting in ongoing hunger.

In addition, food suppliers often have excess food that results in food waste. For example, grocery stores may have food items that are nearing or have passed their expiration date but are still useable and edible. This is especially true for produce items or prepared food items meant to simply be cooked/warmed up at home. These items often have a short shelf life and, if not purchased in time, are disposed of. Likewise, restaurants often have a surplus of food supplies and/or prepared food. These surplus food items may result from, e.g., over-ordering (e.g., actual orders from customers being less than expected), decreased business/orders, or the like. Surplus prepared food may result from last-minute order cancellations, too much food being made (e.g., for catering orders), errors made during the food preparation process, orders not being picked up, leftover items being sold at events/festivals, or the like.

According to aspects of the present disclosure, methods and systems are provided that match and connect consumers in need of food with a vendor according to information associated with the respective parties. A “vendor” is intended to include any entity offering a good, e.g., food items or excess food items. A vendor may include food suppliers, such as a grocery store, restaurant, and the like. “Food” is intended to include any consumable commodity or product, including, for example, prepared food, groceries, drinks, and beverages. The systems and methods promote minimal and efficient communication between the parties, taking into account the vendor's location and offerings and matching the vendor with a user whose information and preferences were previously input into a database and stored by the system.

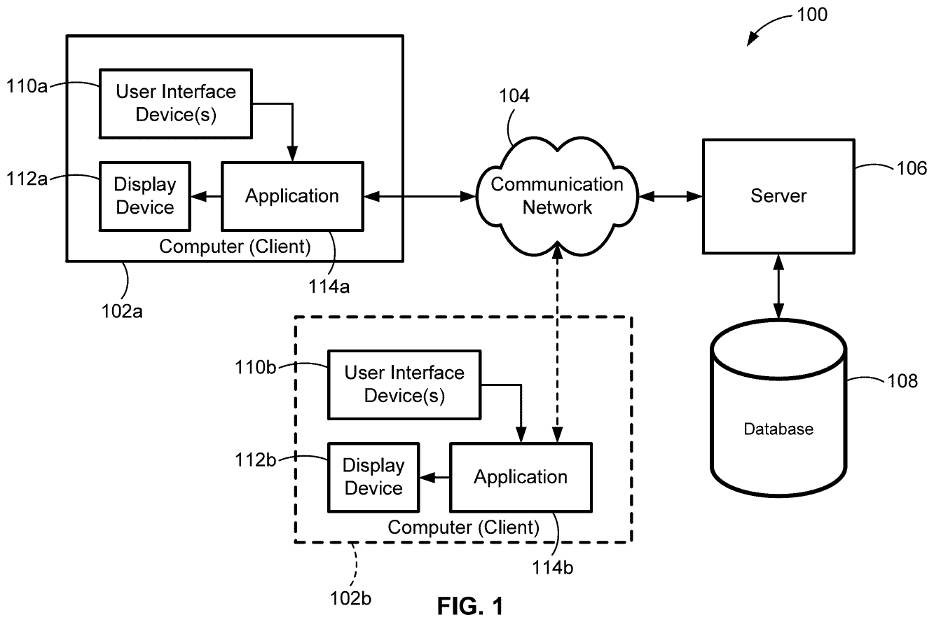

FIG. 1 is a functional block diagram of a system 100 according to an aspect of the present disclosure. First, the general components of the system 100 will be introduced, followed by examples. The system 100 includes one or more electronic computers 102a, 102b. Reference numbers used herein without a letter can refer to a specific one of the plurality of items, a subset of multiple items of the plurality of items, or all items of the plurality of items so numbered with the same reference number. Thus, by way of example, the reference number 102 can refer to the computer 102a, the computer 102b, or both of the computers 102a and 102b, as shown in FIG. 1.

The one or more computers 102a, 102b connect to a communication network 104, such as the Internet. However, the communication network 104 can be any type of electronic communication network. A computer as used herein includes any one or more electronic devices having a central processing unit (CPU) or controller or microprocessor or microcontroller as understood by those skilled in the art of electronic computers. Examples of computers include tablet computers, laptop computers, desktop computers, servers, smartphones, a wearable electronic device such as a watch, an eyeglass, an article of clothing, a wristband, personal digital assistants (PDAs), or the like. The term computer as used herein can include a system of electronic devices coupled together to form what is conventionally referred to as a computer. For example, one or more input devices, such as a keyboard or a mouse, and one or more electronic display devices, such as a video display, can be coupled to a housing that houses the CPU or controller. Or, all components of the computer can be integrated into a single housing, such as in the case of a tablet computer or a smartphone. The one or more computers 102a, 102b conventionally include or are operatively coupled to one or more memory devices that store digital information therein, including non-transitory machine-readable instructions and data.

The one or more computers 102a, 102b include user interface devices 110a, 110b. Each user interface device 110a, 110b corresponds to a human-machine interface (HMI) that accepts inputs made by a human (e.g., via touch, click, gesture, voice, etc.) and converts those inputs into corresponding electronic signals. Non-limiting examples of user interface devices 110a, 110b include a touchscreen, a keyboard, a mouse, a camera, and a microphone. These are also referred to as human-machine interface devices because they allow a human to interact with a machine by providing inputs supplied by the human user to the machine.

The one or more computers 102a, 102b also include electronic display devices 112a, 112b that are configured to display information that can be visually perceived. Non-limiting examples of display devices 112a, 112b include an electronic video display, a stereoscopic display, or any electronic display configured to visually portray information including text, static graphics, and moving animations that is perceivable by the human eye. The electronic display devices 112a, 112b display visual information contained in an electronic user interface (UI). The electronic UI can also include selectable elements that are selectable using the one or more HMI devices 110a, 110b. Thus, the electronic UI generally can include a graphical user interface (GUI) component and a human-machine user interface component, via which a human user can select selectable elements displayed on the GUI via the HMI interface.

The one or more computers 102a, 102b also include software applications 114a, 114b. That is, the one or more computers 102a, 102b execute non-transitory machine-readable instructions and data that implement the software applications 114a, 114b. The applications 114a, 114b perform one or more functions on the one or more computers 102a, 102b. The applications 114a, 114b can be various specific types of applications, such as a web browser application, a native application, or a mobile application. Within the system 100, the applications 114a, 114b convey information between the one or more computers 102a, 102b and the communication network 104 (e.g., Internet) via a conventional wired or wireless electronic communications interface associated with the one or more computers 102a, 102b. Alternatively, or in addition, the applications 114a, 114b can be a native application. Native applications convey information between the one or more computers 102a, 102b over the communication network 104 to an application server 106. The native applications 114a, 114b conventionally convey information between the one or more computers 102a, 102b over the communication network 104 via a conventional wired or wireless electronic communications interface associated with the one or more computers 102a, 102b.

As described above, the server 106 is also coupled to the communication network 104. The server 106 is a type of computer, and has a well understood meaning in the art. The server 106 can be, for example, a web browser server, such as in the case of applications 114a, 114b being web browser applications. Alternatively, the server 106 can be, for example, a native application server, such as in the case of applications 114a, 114b being native applications.

An electronic database 108 (e.g., first database 108a and second database 108b) is incorporated in or is coupled to the server 106. The database 108 is a form of a memory device or a data storage that stores electronic data for retrieval and archival relative to the server 106. Both the server 106 and the one or more applications 114a, 114b communicate information according to one or more protocols, such as the hypertext transfer protocol (HTTP) in the case of the communication network 104 being the Internet. In the case of the communication network 104 being a private local area network (LAN), instead of the Internet, any other communications protocol can be used instead of the HTTP. For example, native applications can instead communicate using a proprietary or conventional communications protocol to pass information between the one or more computers 102a, 102b and the server 106.

Although the system 100 is shown generally with respect to FIG. 1 as including two computers 102a, 102b, one server 106, and one database 108, the system 100 can include any number of computers 102a, 102b, any number of independent or clustered servers 106 (e.g., server farm or sever cluster), and any number of databases 108. Moreover, some or all functionality of one or more components of the system 100 can be transferred, in whole or in part, to other components of the system 100. By way of example, functionality of the server 106 and/or the database 108 can be transferred, in whole or in part, to the one or more computers 102a, 102b, depending on the functionality and performance of the computers 102a, 102b.

In some implementations, the one or more computers 102a, 102b includes a global positioning system (GPS) receiver for communicating position information to the server 106.

According to one embodiment, the applications 114a, 114b may communicate with the server 106 and the database 108 over the communication network 104 for matching a vendor's availability offer to at least one user whose profile substantially aligns with the availability offer. The availability offer may include, e.g., any type of food item, including, but not limited to, grocery store items, farm produce, prepared food items, restaurant menu items, any combination thereof, or the like. The applications 114a, 114b control the user interface devices 110a, 110b and the display devices 112a, 112b to present the availability offer to the selected user(s) and to receive inputs from the user(s) indicating interest and/or acceptance of the availability offer. The information is communicated over the communication network 104 to the applications 114a, 114b of the one or more computers 102a, 102b from the database 108, either directly or through the server 106.

Accordingly, based on a user-server arrangement of the system 100, with the computers 102a, 102b as the user and the server 106 as the server, the database 108 stores the information used for determining which user is best suited for the availability offer. In some embodiments, the server 106 incorporates GPS information from the users' computers 102a, 102b and performs the functionality of the algorithms described herein, including serving the information from the database 108 to the users (e.g., computers 102a, 102b). The computers 102a, 102b present the information to the user and receive the inputs from the user, which are then presented to the server 106 for processing. However, the functionality disclosed herein with respect to the disclosed algorithms can be divided among the components of the system 100 differently than as explicitly disclosed, without departing from the present disclosure. For example, all of the functionality disclosed herein can be embodied in one or more of the computers 102a, 102b, such as the computers 102a, 102b being arranged as a distributed network, depending on the capability of the computers 102a, 102b.

The information stored in the database 108 can be of various file formats and types. In one non-limiting embodiment illustrated in FIG. 1, the database 108 includes a first database 108a and a second database 108b. The first database 108a electronically stores information associated with a plurality of vendors, and the second database 108b electronically stores information associated with a plurality of users.

The plurality of vendors may include any vendor, entity, business, company, or the like offering food products. For example, the plurality of vendors may include farms, restaurants, diners, concession stands, take-out counters, food cooperatives, grocery stores, butcher shops, convenience stores, any combination thereof, or the like.

The system 100 can initially require that each vendor register by prompting the vendor to input certain information into the first database 108a. In some embodiments, the prompts include required prompts and optional prompts. The prompts—and types thereof—presented to the vendors can be defined by the administrator of the system 100. In some embodiments, the system 100 also allows for vendors to add additional (e.g., non-prompted) information into the system 100 as needed/desired. It may be desirable for vendors to input as much information into the first database 108a, e.g., as many responses to the prompts and/or additional information, as possible to ensure that their availability offers best align with a matched user.

The information input by the vendor and stored in the first database 108a may include any suitable type of vendor information, e.g., the type of vendor, location of the vendor, product offerings, dietary restrictions (e.g., allergy information, vegetarian, pescatarian, vegan, kosher, etc.), or the like. The type of vendor information may include whether the vendor is a farm, restaurant, diner, concession stand, take-out counter, food cooperative, grocery store, butcher shop, convenience store, any combination thereof, or the like. Vendor location information may include the physical location of the vendor and/or the location at which the user would pick up the availability offer. The information stored in the first database 108a may also include the type of food generally offered, sold, or served by the vendor. For instance, the vendor may input that it is a restaurant whose primary food offerings are or are primarily American, Italian, Chinese, Indian, Polish, or the like. In another non-limiting embodiment, the vendor may input that it is a butcher shop whose primary food offerings are or are primarily raw chicken, beef, pork, lamb, or the like. The inputted information may also include menu items offered at the vendor (e.g., restaurant). The inputted information may further include dietary restrictions (e.g., a list of common allergens included in the foods items that may be offered, whether the food items are vegetarian, pescatarian, vegan, kosher, etc.). For example, in the non-limiting case of a restaurant vendor or a grocery store vendor, a list of menu/food items offered therein may be stored in the first database 108a, and each of those menu/food items may further include a list of common allergens (e.g., wheat, gluten, shellfish, nuts, soy, dairy) included in that menu/food item. Each menu/food item may also or alternatively include a portion size (e.g., how many people the item is intended to feed) and/or any other suitable information.

As briefly discussed above, the second database 108b electronically stores information associated with a plurality of users. In some embodiments, a “user” referenced herein is a single individual. In other embodiments, the user is representative of a family, a school, a homeless shelter, a halfway house, a domestic abuse shelter, a charitable organization, or any person or entity in need of food items.

The system 100 can also initially require that each user register by prompting the user to input certain information into the second database 108b. In some embodiments, the prompts include required prompts and optional prompts. The prompts—and types thereof—presented to the users can be defined by the administrator of the system 100. In some embodiments, the system 100 also allows for users to add additional (e.g., non-prompted) information into the system 100 as needed/desired. It may be desirable for users to input as much information into the first database 108a, e.g., as many responses to the prompts and/or additional information, as possible to ensure that their availability offers best align with a vendor's availability offer.

In some embodiments, a user's response to a first prompt or series of initial prompts causes the system 100 to initiate a corresponding second prompt or series of prompts. In one non-limiting example, when a user indicates that he or she has a food restriction in response to a first inquiry, the system 100 initiates a subsequent set of food restriction-specific prompts (e.g., types of allergies, whether the user is vegetarian, pescatarian, vegan, kosher, or the like) and sub-prompts.

In some embodiments, the prompts include required prompts and optional prompts. The prompts—and types thereof—presented to the users can be defined by the administrator of the system 100. In some embodiments, the system 100 also allows for users to add additional information into the system 100 as needed/desired. It may be desirable for users to input as much information into the second database 108b, e.g., as many responses to the prompts, as possible to ensure that the user information best aligns with an availability offer.

According to one non-limiting embodiment, the system 100 can initially require that each of the plurality of users register and/or pre-qualify by prompting the user to input certain information into the second database 108b. According to some embodiments, the system 100 initially prompts the user to input information required to pre-qualify the user as being “in need.” It is contemplated that any suitable information may be requested to pre-qualify the user as being in need including, but not limited to, verification that the user's (or the user's family's) income falls below a predetermined threshold, employment status, 501(c)(3) status, any combination thereof, or the like.

The information input by the user and stored in the second database 108b may further include any suitable type of user information. For example, the user information may include location information, e.g., where the user lives or is located, how far the user is willing to travel to retrieve an availability offer, any combination thereof, or the like.

The information input by the user may further include allergy information, dietary restrictions, food preferences, the amount of people for which food is ideally sought, the ages of the people for which food is sought, the time of day that the user prefers to cat/serve meals, or the like. For example, the user may input into his/her profile to be stored in the second database 108b that he/she or a family member is allergic to wheat, gluten, shellfish, nuts, soy, dairy, or the like, or that he/she or a family member is vegetarian, pescatarian, vegan, kosher, or the like. In another example, the user may input into the second database 108b that his/her preferred type of food is primarily American, Italian, Chinese, Indian, Polish, or the like. In some embodiments, the system 100 may prompt user to rank the different types of food offerings from most preferred to least preferred. In other embodiments, the user may rate each of the types of food offerings (e.g., 1-5, 1 being least desirable and five being most desirable). In another non-limiting example, the user's profile may include a desired portion size (e.g., how many people the item is intended to feed, how many members are in the user's family, how many people are in the user's facility, or the like). In other embodiments, the user may input whether and how many family members are children and/or the ages thereof so that they may be considered for child-friendly offerings and meals. In still other embodiments, the user may input the times of day that he/she prefers to cat meals. For example, the user may specify that he/she prefers having lunch from 12 PM-2 PM and dinner from 5 PM-7 PM. In other embodiments, a user may specify that he/she does not have any time preferences.

In another example, the system 100 may prompt the user for access to the user's location. If permission is granted, the user's computer 102a, 102b can provide GPS signals that allow the server 106 to know the user's location, provided by the GPS signals, relative to the vendor providing an availability offer.

In other embodiments, the second database 108b may also store historic offer/acceptance information in the user's profile. The historic offer/acceptance information may include elapsed time since a prior availability offer was made, elapsed time since acceptance of a last availability offer, a total amount of availability offer sent to the user (during the history of the user's enrollment or within a certain predetermined time period), a total amount of availability offer acceptances (during the history of the user's enrollment or within a certain predetermined time period), or any combination thereof. The historic offer/acceptance information may be used as a factor in determining whether an availability offer should be sent to a user. For example, if a rating associated with a user's historic offer/acceptance information is high (e.g., the user had received more than a predetermined number of offers/acceptances within a predetermined time period), that user may be less likely to be contacted about a current availability offer such that other users having lower historic offer/acceptance ratings (e.g., no or few offers and/or acceptances within a predetermined time period) may be given opportunities to accept the current availability offer.

According to one embodiment, a matching engine can be used to match a vendor and its availability offer to a user whose preferences and information (e.g., information stored in the second database 108b) substantially align with the information associated with the availability offer. The matching engine may use constraint programming techniques to determine which user to select. The system 100 may then electronically transmit or display the availability offer and an acceptance prompt to the selected user. For example, the matching engine may take into account factors including allergy information, dietary restrictions, distance/travel time to the vendor, food preferences, and historic offer/acceptance information.

In one non-limiting embodiment, a user selection score can be computed for each user according to a weighted formula as expressed in the following:

$$User Selection Score = ( Dietary Restriction Match * x ) [ ( Distance / Time Value * {w}_{1} ) + ( Food Preference Value * {w}_{2} ) + ( Historic Offer / Acceptance Value * {w}_{3} ) + ( Serving Size Value * {w}_{4} ) + ( Time of Day Value * {w}_{5} ) ] \qquad ( Eqn . 1 )$$

It is contemplated that other equations may be used to identify at least one matching user whose data best aligns with the availability offer. It is also contemplated that other (e.g., different, more, or less) factors may be used to identify the at least one matching user whose data best aligns with the availability offer.

In some non-limiting implementations, the values of each of the weights w₁, w₂, w₃, w₄, and w₅ in Eqn. 1 is between 0 and 10. If one of the factors is not applicable (e.g., if information relating to that particular factor is not available, e.g., has not been entered and/or stored in the second database 108b, or it is not relevant to the offering, or the like), then that value associated with that factor may be assigned a default value.

It is contemplated that the weight values of Eqn. 1—w₁, w₂, w₃, w₄, and w₅—may be selected based on the predetermined importance of that value in selecting the user to whom the availability offer is to be made. For example, in embodiments where the distance/time between the user and the vendor/availability offer pick-up location was predetermined to be the most important, the w₁ value of Eqn. I will be proportionally higher than the remaining w₂, w₃, w₄, and w₅ values. In some embodiments, these weight values are determined by or with the input of the specific vendor, and that information is stored in the first database 108a. In other embodiments, the system 100 determines the weight values, and they are applied as such universally for all vendors and availability offers.

Dietary Restriction Match. As briefly noted above, if a vendor indicates that the availability offer includes an allergen or ingredient than a user is allergic to, or a restricted food item (e.g., meat, non-kosher, wheat, gluten, shellfish, nuts, soy, dairy, any combination thereof, or the like) then that dietary restriction-matched user is eliminated from the plurality of users considered for the availability offer. In embodiments in which Eqn. 1 is used, the Dietary Restriction Match value x would equal 0 (zero). As such, that user having dietary restriction matching the offered food item would have a User Selection Score of 0 (zero), and that user would be taken out of contention from being sent an offer notification. If the food item being offered in the availability offer does not include any of the dietary restrictions input by the user and stored in the second database 108b, the Dietary Restriction Match value (x in Eqn. 1) would be one, and the user would be in contention for the availability offer.

For example, if the availability offer is three cheese pizzas, and the user is allergic to milk ingredients, the x-value for that user will be zero, thereby making the user's user selection score zero; as such, that user will be ineligible for that particular availability offer. If there is no allergen or dietary restriction common to the user and the availability offer, the user's x-value in Eqn. 1 will be one (1).

Distance/Time from Vendor. Another factor that may be used in identifying at least one matching user whose data substantially aligns with the availability offer (e.g., the User Selection Score) is the distance and/or travel time between the user and the vendor providing the availability offer. In other embodiments in which the user granted permission to track his/her location, the user's computer 102a, 102b can provide GPS signals that allow the server 106 to know the user's location, provided by the GPS signals, relative to the vendor providing an availability offer and/or the location at which the availability offer to be picked up. In other embodiments, e.g., where the user did not provide permission to track his/her location using GPS signals, the location between the user's home address/place of residence may be used. In other embodiments, GPS signals and/or navigation data gathered by the server 106 may be used to calculate the estimated distance and/or travel time between the user's residence and/or current location. In some embodiments, the shorter the distance, travel time, or combination thereof between the user's location or residence and the location of the vendor or location at which the availability offer to be picked up, the higher the Distance/Time Value assigned to a particular user.

In one non-limiting example, a distance of less than 1 mile between the user and the vendor/pick-up location is associated with a Distance/Time Value of 10, a distance of 1-2 miles is associated with a Distance/Time Value of 9, a distance of 2-3 miles is associated with a Distance/Time Value of 8, a distance of 3-4 miles is associated with a Distance/Time Value of 7, a distance of 4-5 miles is associated with a Distance/Time Value of 6, a distance of 5-6 miles is associated with a Distance/Time Value of 5, a distance of 6-7 miles is associated with a Distance/Time Value of 4, a distance of 7-8 miles is associated with a Distance/Time Value of 3, a distance of 8-9 miles is associated with a Distance/Time Value of 2, a distance of 10 or more miles is associated with a Distance/Time Value of 1.

In other embodiments, a travel time of 1-2 minutes between the user's location and the vendor's location is associated with a Distance/Time Value of 10, a travel time of 2-3 minutes is associated with a Distance/Time Value of 9, a travel time of 3-4 minutes is associated with a Distance/Time Value of 8, a travel time of 4-5 minutes is associated with a Distance/Time Value of 7, a travel time of 5-6 minutes is associated with a Distance/Time Value of 6, a travel time of 6-7 minutes is associated with a Distance/Time Value of 5, a travel time of 7-8 minutes is associated with a Distance/Time Value of 4, a travel time of 8-9 minutes is associated with a Distance/Time Value of 3, a travel time of 9-15 minutes is associated with a Distance/Time Value of 2, a travel time of 15-20 minutes is associated with a Distance/Time Value of 1, and a travel time of more than 20 minutes is associated with a Distance/Time Value of 0. It is contemplated that the Distance/Time Value may be determined using other suitable methods, data, or combinations thereof.

Food Preference. Another factor that may be used in identifying at least one matching user whose data substantially aligns with the availability offer (e.g., the User Selection Score) is whether/how the user's food preferences match with those associated with the availability offer. The user's food preferences may be matched to the availability offer in any suitable way. For example, in one embodiment, the Food Preference Value matches directly with the ranking provided by the user and stored in the second database 108b. For example, in some embodiments, the information stored in the second database 108b includes the user's ranking for each of the possible food preferences on a scale of, e.g., 1-10, where 10 is the most preferred and 1 is the least preferred. For example, if the availability offer is for Japanese food, and the user previously rated/ranked Japanese food with a 5, then the Food Preference Value of Eqn. 1 is 5. If the user rated Japanese food more highly, giving it a value of, e.g., 7, then the value of Food Preference Value of Eqn. 1 is a 7, which results in a higher User Selection Score. In another embodiment, the information stored in the second database 108b includes the order of the user's most preferred to least preferred food types, e.g., the most preferred having a value of 10 and the least preferred having a value of 1. For example, if the availability offer is Italian food, and the user ranked Italian food as an 8/10, or third of ten options, the Food Preference Value is 8.

Historic Offer/Acceptance Information. Another factor that may be taken into account in identifying at least one matching user whose data substantially aligns with the availability offer (e.g., the User Selection Score) is based on historic offer/acceptance information associated with the user, for example, as discussed above. The purpose of this factor is to attempt to spread the availability offers to as many different users as possible, i.e., so that a single user or group of users is not receiving a disproportionate amount of availability offers. Any suitable algorithm may be used to determine the user's Historic Offer/Acceptance Value. For example:

$$Historic Offer / Acceptance Value = - [ ( No . offers in past X days ) ( {y}_{1} ) + ( No . acceptances in past X days ) ( {y}_{2} ) ] \qquad ( Eqn . 2 )$$

X in Eqn. 2 may be set to any predetermined time period, e.g., 7 days, 30 days, or the like. It is contemplated that other measures of time may be used such as, for example, hours, months, years, any combination thereof, or the like. The values of each of y₁ and y₂ in Eqn. 2 may, for example, be between 0 and 10. In some non-limiting embodiments, y₂ is greater y₁ such that the number of acceptances is given more weight than the number of offers. In Eqn. 2, the historic offer/acceptance information value is negative such that the more offers and/or acceptances a user has had in the past X days, the lower the resulting User Selection Score will be. In other embodiments, the Historic Offer/Acceptance Value simply corresponds with the amount of time (e.g., days) that have elapsed since the user last received an availability offer, last accepted an availability offer, or any combination thereof.

Serving Size Preference Information. The Serving Size Value, if used in identifying the at least one matching user, may be determined in any suitable manner. In one non-limiting example, the Serving Size Value is determined as follows:

$$Serving Size Value = - \vert Size offered by vendor - Size needed by user \vert \qquad ( Eqn . 3 )$$

As such, in Eqn. 3, the Serving Size Value is negative such that the greater the discrepancy between the serving size offered by the vendor and the serving size needed by the user, the lower the User Selection Score will be.

Time of Day Preference. The Time of Day Value may be determined in any suitable manner. For example, if a user's preferred time period (e.g., breakfast, lunch, or dinner) to receive an availability offer matches or more closely matches that of the availability offer, the Time of Day Value is higher. In one embodiment, if the user's preferred time of day has not been entered, or if the user's entered preferred time of day does not match the time of day of the availability offer a default value is entered for the Time of Day Value.

In some embodiments, another factor in identifying at least one matching user from the plurality of users includes whether the availability offer includes child-friendly options and/or whether the user's preferences indicate that he/she has family members under a predetermined age (e.g., 12 years old). In some embodiments, a match regarding a child-friendly offering and a child family member makes increases the user's chances of being selected as a matching user.

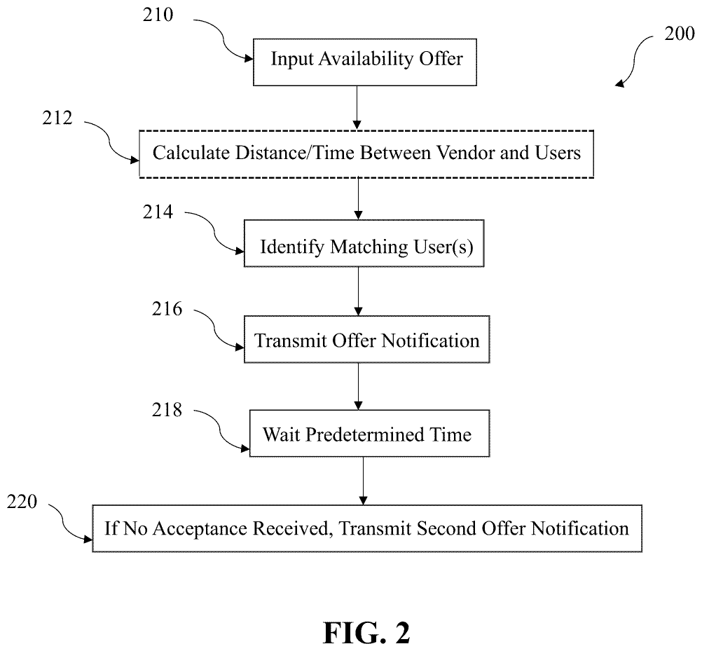

FIG. 2 illustrates one non-limiting example of a method 200 of matching a vendor supplying food products with a user seeking food products. The steps of the methods below may be performed in any order, and any one or more of the steps may be optional or eliminated, and other suitable steps may also be included.

In one non-limiting embodiment, a vendor may utilize a user interface device 110a, 110b (e.g., a keyboard, touch screen, voice-activated feature, or the like) of a computers 102a, 102b to log into a software application 114a, 114b for matching a food availability offer to a user seeking food products. The first database 108a includes stored information associated with the vendor. Such information may include a location, a type of food being offered, an amount of food being offered, dietary restrictions associated with the type of food being offered, or any combination thereof. Once the vendor is logged into the application 114a, 114b, information about the availability offer may be input or selected from previously entered information at step 210. The vendor may optionally be given an opportunity to provide additional information about the availability offer.

Once the availability offer and information associated therewith is input into the software application 114a, 114b, at step 212, the system 100 may compare information associated with the availability offer to data associated with a plurality of users to identify at least one matching user from the plurality of users whose data aligns with the availability offer at step 214. In some embodiments, comparing information associated with the availability offer to the data associated with the plurality of users includes ranking the plurality of users based on how closely the data associated with each of the plurality of users aligns with information associated with the availability offer, where the at least one matching user has the highest ranking.

The data associated with a plurality of users includes user profile data information previously input by each of the plurality of users and stored in the second database 118b. The user profiles stored in the second database may include food preferences, dietary restriction information, an amount of family members, ages of family members, information associated with past availability offers, information associated with past availability offer acceptances, or any combination thereof. The user profiles stored in the second database 108b may include a prior acceptance value determined by historic acceptance information stored in the second database 108b for each of the plurality of users. The historic acceptance information of each of the plurality of users may include a time period since a prior offer notification, a time period since acceptance of a last offer notification, a total amount of offer notifications, a total amount of offer notification acceptances, any combination thereof, or the like. The user profiles stored in the second database 108b may include pre-qualification information establishing the user's need.

In one embodiment, at optional step 214, GPS signals, navigation data, or a combination thereof are used to calculate the estimated distance, travel time, or a combination thereof between each of the plurality of users' locations and a location associated with the vendor. As such, the plurality of users whose profiles are stored in the second database 108b may be filtered using the GPS data. For example, the system 100 may eliminate any users that either reside at or are currently located more than a predetermined distance from the vendor or the pick-up location for the availability offer. In another example, the system 100 may eliminate any users whose travel time, determined using GPS signals, from their residence or current location to the vendor or the pick-up location is greater than a predetermined amount of time. In another example, a higher location weight value is assigned to each of the plurality of users located a shorter distance away from or having a shorter travel time to the vendor location.

At step 216, at least one matching user from the plurality of users whose data most closely aligns with the availability offer may be identified. This step may include weighting at least one piece of information associated with the plurality of users based on a predetermined importance of the at least one piece of information in matching the vendor to the user. For example, in embodiments where it has been predetermined that the amount of time elapsed since a user's last availability offer or acceptance is particularly important, that factor will be given more weight in identifying the at least one matching user.

At step 218, an offer notification and an acceptance prompt are transmitted to a first device of the at least one matching user. The offer notification includes information associated with the availability offer. In embodiments where the at least one matching user is a plurality of users, a “first come, first served” basis may be implemented, where an electronic match notification is transmitted to the first of the plurality of matching users to indicate acceptance of the offer notification and an offer cancellation is electronically transmitted to the remaining matching users. The match notification may provide further details about the availability offer, pick-up details, or the like.

At step 218, the system 100 may wait a predetermined time period for a feedback signal from the first device indicating acceptance of the offer notification. At step 220, if such feedback signal is not received within the predetermined time period, an offer cancellation notice may be electronically transmitted to the first device, and the offer notification may be transmitted to a second device of a second at least one matching user. In some embodiments, the second at least one matching user has a second highest ranking.

In Table 1 below, exemplary User Selection Scores for five users is shown, based on the information provided. In this non-limiting example, Eqns. 1 and 2 were used to calculate the User Selection Scores, and w₁=5, w₂=2, w₃=5, w₄=0.5, w₅=3, y₁=0.2, and y₂=0.8. It is contemplated that any suitable values may be assigned to w₁-w₅. In the Example of Table 1, the serving size is of the availability offer is 12, and the time of the offer is dinnertime.

TABLE 1

| | | | | | | Days | | | | |
|---|---|---|---|---|---|---|---|---|---|---|
| | | Dietary | | | Food | Elapsed | Serving | | Time of | User |
| | | Restriction | Distance/Time | | Preference | Since Last | Size | | Day | Selection |
| User | | Match | from Vendor | | Rating | Acceptance | Preference | | Preference | Score (USC) |
| 1 | Value | 0 | 7 | | 10 | 1 | 8 | | 1 | USC = 0[(7*5) + |
| | User | Milk | 3.5 | miles | Ranked | 1 offer and 0 | 4 | people | Time | (10*2) − (1*5) − |
| | information | allergy | | | 1/10 | acceptances | | | preference | (8*0.5) + 1] = 0 |
| | | | | | | in past 30 | | | not entered, | |
| | | | | | | days | | | default value | |
| | | | | | | | | | of 1 used | |
| 2 | Value | 1 | 6 | | 10 | 0 | 16 | | N/A | USC = 1[(6*5) + |
| | User | No | 4.8 | miles | Ranked | 0 offers and 0 | 28 | people | Time | (10*2) − (0*5) − |
| | information | allergies | | | 1/10 | acceptances | | | preference | (16*0.5) + 1] = 59 |
| | | | | | | in past 30 | | | not entered, | |
| | | | | | | days | | | default value | |
| | | | | | | | | | of 1 used | |
| 3 | Value | 1 | 8 | | 5 | 2.4 | 4 | | 1 | USC = |
| | User | No | 2.3 | miles | Ranked | 8 offers and 1 | 8 | people | Dinner | 1[(8*5) + (5*2) − |
| | information | allergies | | | 5/10 | acceptances | | | time | (2.4*5) − (4*0.5) + |
| | | | | | | in past 30 | | | preferred | (1*5)] = 41 |
| | | | | | | days | | | | |
| 4 | Value | 0 | 1 | | 8 | 1 | 0 | | 0 | USC = 0[(1*5) + |
| | User | Vegan | 13 | miles | Ranked | 1 offer and 1 | 12 | people | Lunch time | (8*2) − (1*5) − |
| | information | | | | 8/10 | acceptance | | | preferred, | (0*0.5) + 0] = 0 |
| | | | | | | in past 30 | | | default | |
| | | | | | | days | | | value of 0 | |
| | | | | | | | | | entered | |
| 5 | Value | 1 | 10 | | 3 | 2.6 | 6 | | 0 | USC = 1[(10*5) + |
| | User | No | 0.9 | miles | Ranked | 5 offers and 2 | 6 | people | Breakfast | 3*2) − (2.6*5) − |
| | information | allergies | | | 3/10 | acceptances | | | time | (6*0.5) + 0)] = 40 |
| | | | | | | in past 30 | | | preferred, | |
| | | | | | | days | | | default | |
| | | | | | | | | | value of 0 | |
| | | | | | | | | | entered | |

Thus, in the example of Table 1, because User 2 has the greatest User Selection Score of 59, the availability offer is transmitted to User's 2 device.

In some embodiments, the user or users having the highest User Selection Score have a certain time period to accept the availability offer before the offer “times out” and is offered to a next user or users. In other embodiments, the amount of availability offer sent depends on the amount of time remaining to pick up the availability offer. For example, if the vendor has only a short amount of time before closing, the availability offer may be sent to a greater amount of users, on a first come, first served basis, to increase the possibility that the offer will be accepted in time.

It is contemplated that the methods and systems described herein may be used outside of the food industry. For example, the goods offered may include clearance/discontinued items not otherwise sold by a retail establishment, airline tickets, sporting events, concert, theater, other event tickets, or the like.

Each of the above embodiments and obvious variations thereof are contemplated as falling within the spirit and scope of the claimed invention, which is set forth in the following claims. Moreover, the present concepts expressly include any and all combinations and sub-combinations of the preceding elements and aspects.

It should be noted that the terms “exemplary” and “example” as used herein to describe various embodiments are intended to indicate that such embodiments are possible examples, representations, and/or illustrations of possible embodiments (and such terms are not intended to connote that such embodiments are necessarily extraordinary or superlative examples).

Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes, and omissions may also be made in the design, operating conditions, and arrangement of the various exemplary embodiments without departing from the scope of the present invention.

What is claimed is:

1. A method of matching vendors supplying food products with users that seek food products, the method comprising:
storing information associated with a plurality of vendors in a first database;
storing user profiles associated with a plurality of users in a second database;
receiving an availability offer based on input from one of the plurality of vendors;
comparing information associated with the availability offer to data associated with the plurality of users, the data including information stored in the second database, to identify at least one matching user from the plurality of users whose data aligns with the availability offer;
electronically transmitting an offer notification and an acceptance prompt to a first device of the at least one matching user, the offer notification including information associated with the availability offer;
waiting a predetermined time period for a feedback signal from the first device indicating acceptance of the offer notification; and
if the feedback signal is not received within the predetermined time period, electronically transmitting an offer cancellation notice to the first device and electronically submitting the offer notification to a second device of a second at least one matching user.

2. The method of claim 1, wherein the user profile associated with the plurality of users in the second database include a first set of information previously input by each of the plurality of users.

3. The method of claim 1, wherein the method further includes gathering at least a portion of the second set of information using GPS signals, navigation data, or a combination thereof to calculate the estimated distance, travel time, or a combination thereof between each of the plurality of users' locations and a location associated with the vendor, the data associated with the plurality of users including the estimated distance, travel time, or combination thereof.

4. The method of claim 3, wherein the comparing information associated with the availability offer to data associated with the plurality of users includes
comparing the GPS signals, navigation data, or a combination associated with the plurality of users with vendor location information stored in the first database, and
assigning a higher location weight value to each of the plurality of users being located a shorter distance away from or having a shorter travel time to the vendor location.

5. The method of claim 1, wherein the user profiles associated with the plurality of users includes food preferences, dietary restriction information, an amount of family members, ages of family members, information associated with past availability offers, information associated with past availability offer acceptances, or any combination thereof.

6. The method of claim 1, wherein the user profiles associated with the plurality of users includes a prior acceptance value, the prior acceptance value being determined by historic acceptance information being stored in the second database for each of the plurality of users, the historic acceptance information of each of the plurality of users including a time period since a prior offer notification, a time period since acceptance of a last offer notification, a total amount of offer notifications, a total amount of offer notification acceptances, or any combination thereof.

7. The method of claim 1, wherein the information stored in the second database includes pre-qualification information, the pre-qualification information establishing the user's need.

8. The method of claim 1, wherein the identifying the at least one matching user from the plurality of users whose data most closely aligns with the availability offer includes weighting at least one piece of information associated with the plurality of users based on a predetermined importance of the at least one piece of information in matching the vendor to the user.

9. The method of claim 1, wherein the information associated with the plurality of vendors includes a location, a type of food being offered, an amount of food being offered, dietary restrictions associated with the type of food being offered, or any combination thereof.

10. The method of claim 1, wherein the comparing information associated with the availability offer to the data associated with the plurality of users includes ranking the plurality of users based on how closely the data associated with each of the plurality of users aligns with information associated with the availability offer, the at least one matching user having the highest ranking.

11. The method of claim 10, wherein the second at least one matching user has a second highest ranking.

12. The method of claim 1, wherein the plurality of vendors includes grocery stores, restaurants, or a combination thereof.

13. The method of claim 1, wherein the comparing the availability offer to the information stored in the second database includes:
comparing dietary restriction information, if any, associated with the availability offer to user dietary restriction information stored in the second database to identify dietary restriction-matched users; and
eliminating the dietary restriction-matched users from the plurality of users considered for the availability offer.

14. A system for matching vendors supplying food products with users that seek food products, the system is configured to:
store information associated with a plurality of vendors in a first database;
store user profiles associated with a plurality of users in a second database;
receive an availability offer based on input from one of the plurality of vendors;
compare information associated with the availability offer to data associated with the plurality of users, the data including information stored in the second database, to identify at least one matching user from the plurality of users whose data aligns with the availability offer;
electronically transmit an offer notification and an acceptance prompt to a first device of the at least one matching user, the offer notification including information associated with the availability offer;
wait a predetermined time period for a feedback signal from the first device indicating acceptance of the offer notification; and
if the feedback signal is not received within the predetermined time period, electronically transmit an offer cancellation notice to the first device and electronically submitting the offer notification to a second device of a second at least one matching user.

15. The system of claim 14, wherein the system is further configured to gather at least a portion of the second set of information using GPS signals, navigation data, or a combination thereof to calculate the estimated distance, travel time, or a combination thereof between each of the plurality of users' locations and a location associated with the vendor, the data associated with the plurality of users including the estimated distance, travel time, or combination thereof.

16. The system of claim 15, wherein the comparing information associated with the availability offer to data associated with the plurality of users includes
comparing the GPS signals, navigation data, or a combination associated with the plurality of users with vendor location information stored in the first database, and
assigning a higher location weight value to each of the plurality of users being located a shorter distance away from or having a shorter travel time to the vendor location.

17. The system of claim 14, wherein the user profiles associated with the plurality of users includes food preferences, dietary restriction information, an amount of family members, ages of family members, information associated with past availability offers, information associated with past availability offer acceptances, or any combination thereof.

18. The system of claim 14, wherein the identifying the at least one matching user from the plurality of users whose data most closely aligns with the availability offer includes weighting at least one piece of information associated with the plurality of users based on a predetermined importance of the at least one piece of information in matching the vendor to the user.

19. The system of claim 1, wherein the information associated with the plurality of vendors includes a location, a type of food being offered, an amount of food being offered, dietary restrictions associated with the type of food being offered, or any combination thereof.

20. The system of claim 1, wherein the comparing information associated with the availability offer to the data associated with the plurality of users includes ranking the plurality of users based on how closely the data associated with each of the plurality of users aligns with information associated with the availability offer, the at least one matching user having the highest ranking, and the second at least one matching user has a second highest ranking.
